(19) United States
(12) Patent Application Publication
(10) Pub. No.: US 2016/0025997 A1
(43) Pub. Date: Jan. 28, 2016

(54) EYEGLASS RETAINER DEVICES

(71) Applicant: Richard J. Yribarren, Tranquillity, CA (US)

(72) Inventor: Richard J. Yribarren, Tranquillity, CA (US)

(21) Appl. No.: 14/340,969

(22) Filed: Jul. 25, 2014

(51) Int. Cl. G02C 3/00

(52) U.S. Cl. CPC G02C 3/003

(57) ABSTRACT

An eyewear retention device that comprises two elongate members, each having a receiving end for receiving an end of a temple member of said eyewear, a connecting end having a magnetic fastener, and an elongate portion for wrapping around said human head is disclosed. The magnetic fasteners of the elongate members may be magnetically engaged to each other behind said human head and snuggly hold the eyewear at the bridge of the nose.

### FIELD OF THE INVENTION

The present invention relates to eyewear retaining devices and more particularly to improved eyewear retaining devices that hold eyewear in proper position and that are easily donned and removed, and methods of using the same.

### DISCUSSION OF THE BACKGROUND

Eyeglasses generally include a frame body that holds two lenses, two nose pads for mounting at the bridge of the nose, and two temples that extend from the two lateral ends of the frame body. The temples and nose pads support the frame on the head of the wearer in a position in which the lens are in front of the wearer's eyes. However, due to the weight of the lenses and the absence of significant counter-balancing weight on the back of the eyeglasses, the temples and nose pads frequently are insufficient to prevent the eyeglasses from sliding down the wearer's face. Eyeglass wearers typically correct such shift by pushing upwards on a bridge between the two lenses and over the wearers nose. During vigorous physical activity or during prolonged tasks in which the wearer's hand(s) are unavailable to adjust the eyewear (e.g., where the wearer is working with caustic chemicals or other materials that do not allow the wearer to put his hands near his face), the eyeglasses may shift to a position where the lenses no longer are positioned in front of the wearers eyes, thus preventing the wearer from being able to see (or worse, the eyeglasses may completely fall of the wearer. Such events may expose the wearer to unsafe conditions or may damage the eyeglasses.

Various conventional retainer devices (e.g., eyeglass lanyards) have been used to prevent the eyeglasses from falling from the wearer. Some conventional retainer devices include a means for cinching the retainer such that the device is tight to the back of the wearers head. However, individuals often need to remove their eyeglasses temporarily (e.g., for focusing on objects at different distances, wiping perspiration from the face, etc.), and need an eyeglass retaining device that both holds the eyeglasses snuggly to the bridge of the nose in the proper position (such that the lens are in front of the eyes) while at the same time allowing the eyewear to be easily and comfortably donned and removed. Additionally, individuals may also need to temporarily store the eyeglasses at a location in which they are readily accessible (e.g., by storing the eyeglasses against the wearer's chest and around their neck).

### SUMMARY OF THE INVENTION

The present invention provides an improved eyeglass retention device and more particularly, some embodiments include an eyeglass retention device that may hold eyeglasses snugly to the bridge of wearer's nose.

It is an object of the present invention to provide a device that can hold a pair of eyewear (e.g., reading glasses, sunglasses, etc.) in proper position with the bar (i.e., bridge between the two lenses) and nose pads of the glasses positioned at the bridge of the nose such that the lenses are in front of a wearer's eyes. It is also an object of the present invention to provide an eyewear retainer that can be easily fastened and unfastened behind the wearers head without the need to pull the eyewear and the retainer over the top of the wearer's head.

In some embodiments, and without limitation, the present invention relates to a device for securing eyewear to a human head and preventing the eyewear from slipping from the bridge of the nose, the device including a first elongate member and a second elongate member. Each elongate member may include a receiving end for receiving an end of a temple member of the eyewear, a connecting end having a magnetic fastener, and an elongate portion between the receiving end and the connecting end. The elongate portion may wrap around a portion of the human head. The magnetic fasteners may be adapted such that they magnetically engage each other behind the human head. In some embodiments, the elongate members may be axially elastic such that the elongate members may stretch when the magnetic fasteners are attached to each other. For example, and without limitation, the elongate members (or portions thereof) may be stretched from a resting state when the magnetic fasteners are engaged to each other. In some implementations, the first and second elongate members may be substantially the same length. The elongate members may have lengths and elasticities such that the device accommodates human heads of varying size ranges (for example, and without limitation, having sizes that vary by up to about 1.5 inches in circumference). As such, it is to be appreciated that the device may snuggly hold the eyewear at the bridge of the nose and providing a comfortable fit to humans having various head sizes.

The receiving end may be any of various structures for attaching to the temples of the eyewear, such as a tubular extension into which the end of the temple may be inserted, elastic loops, cinchable loops, and other structures. The term “tubular extension” does not necessary mean a cylindrical tubular structure, and may encompass various other shapes that include an interior elongate recess into which the end of an eyewear temple may be snugly inserted. In some embodiments, the receiving ends may be radially elastic such that. For example and without limitation, the receiving ends may stretch radially outward to receive an end of an eyewear temple having a greater exterior diameter than the interior diameter of the opening in the receiving end in a resting state.

In some implementations, the receiving end may have an outer diameter that is greater than an outer diameter of the elongate portion. In other implementations, the receiving end may have an outer diameter that is greater than the outer diameter of the elongate portion. In some embodiments, the receiving end may be integrally formed with the elongate portion. As used herein, “integrally formed” means that the structures are physically contiguous. In some embodiments, the connecting end may be integrally formed with the elongate portion. In some embodiments, both the receiving end and the connecting end may be integrally formed with the elongate portion. However, in other embodiments, the receiving end and/or connecting end may be separately formed from the elongate portion.

The magnet fasteners may have sufficient size and strength to prevent magnetic disengagement of the magnets during vigorous exercise. At the same time, the magnet fasteners may allow for easy disengagement of the retaining device when a wearer attempts to separate the first and second elongate members. In some embodiments, the magnetic fasteners may be at least partially inserted in an axial opening of the connecting end. For example and without limitation, the magnetic fasteners may be inserted into an inner recess of the connecting end. In some implementations, a distal end of the magnetic fastener may protrude from the axial opening of the connecting end. In some other implementations, a distal end of the magnetic fastener may be flush with a distal end of the connecting end. In some other implementations, the magnetic member may be fully inserted into the axial opening of the connecting end. In some embodiments, the magnetic fastener is attached to a distal end of the connecting end. For example, and without limitation, the magnetic fastener may be glued to a distal end of the connecting end.

The magnetic fastener may be a permanent magnet or comprise ferromagnetic material. In some embodiments, both magnetic fasteners may be permanent magnets. In some embodiments, one of the magnetic fasteners may be a permanent magnet and the other magnetic fastener may comprise ferromagnetic material.

In other embodiments, and without limitation, the present invention relates to a device use with eyewear having a first and second temple portions, the device including a first elongate member and a second elongate member. The first elongate member may have a receiving end capable of tightly receiving an end of the first temple portion of the eyewear, and the second elongate member may have a receiving end capable of tightly receiving and end of the second temple portion of the eyewear. The first elongate member may also have a connecting end having a first magnetic fastener, and the second elongate member may have a second magnetic fastener. Each the first elongate member and the second elongate member may have an elongate portion between the receiving end and the connecting end. In some implementations, the first and the second magnetic fasteners may be oriented with the respective connecting ends of the elongate members such that the magnetic fasteners may be magnetically engaged to each other at the distal ends of the connecting ends.

In some embodiments, the receiving end, the elongate portion, and the receiving end of each of the first and second elongate members may be unitarily formed. In some embodiments, the first and the second magnetic fasteners may be permanent magnets. The magnetic fasteners may be at least partially inserted in an axial opening in the respective connecting ends of the elongate portions. The receiving ends of the elongate portions may include axial openings therein for receiving a proximal end of the respective temple portion of the eyewear.

In further embodiments, and without limitation, the present invention relates to an eyewear retaining device including two elongate members. Each member may have a receiving end having an axial opening therein for receiving an end of one of two temple members of a pair of eyewear. The receiving end may be radially elastic. The elongate member may have a connecting end opposite to the receiving end, and the connecting end may have an axial opening for receiving a magnetic fastener. The elongate member may have an elongate portion between the receiving end and the connecting end, and a portion of the elongate portion may be axially elastic. The first and the second elongate members may have about the same length, and may be adapted to wrap around a human head wearing the pair of eyewear such that the first and the second magnetic fasteners magnetically engage each other at a location behind the human head. In some implementations, the magnetic fastener may include a permanent magnet. In some implementations, the receiving end may be engaged with the elongate portion and may have an outer diameter that is greater than an outer diameter of the elongate portion

Additional aspects and objects of the invention will be apparent from the detailed descriptions and the claims herein.

### BRIEF DESCRIPTION OF THE DRAWINGS

FIG. 1 is a perspective view of an eyewear retaining device according to an embodiment of the present invention.

FIG. 2 is a side view of an eyewear retaining device according to an embodiment of the present invention.

FIG. 3 is a frontal view of an eyewear retaining device according to an embodiment of the present invention.

FIG. 4 is a posterior view of an eyewear retaining device according to an embodiment of the present invention.

FIG. 5 is an overhead view of an eyewear retaining device according to an embodiment of the present invention, where the two sides of the device are separated.

FIG. 6 is a perspective view of an eyewear retaining device according to an embodiment of the present invention, with the eyewear retaining device attached to a pair of glasses.

FIG. 7 is a side view of an eyewear retaining device according to an embodiment of the present invention, with the eyewear retaining device attached to a pair of glasses, and the eyewear retaining device and the glasses being worn by a person.

FIG. 8 is an overhead view of an eyewear retaining device according to an embodiment of the present invention, where the two sides of the device are separated.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention as defined by the claims. In the following disclosure, specific details are given to provide a thorough understanding of the invention. However, it will be apparent to one skilled in the art that the present invention may be practiced without these specific details.

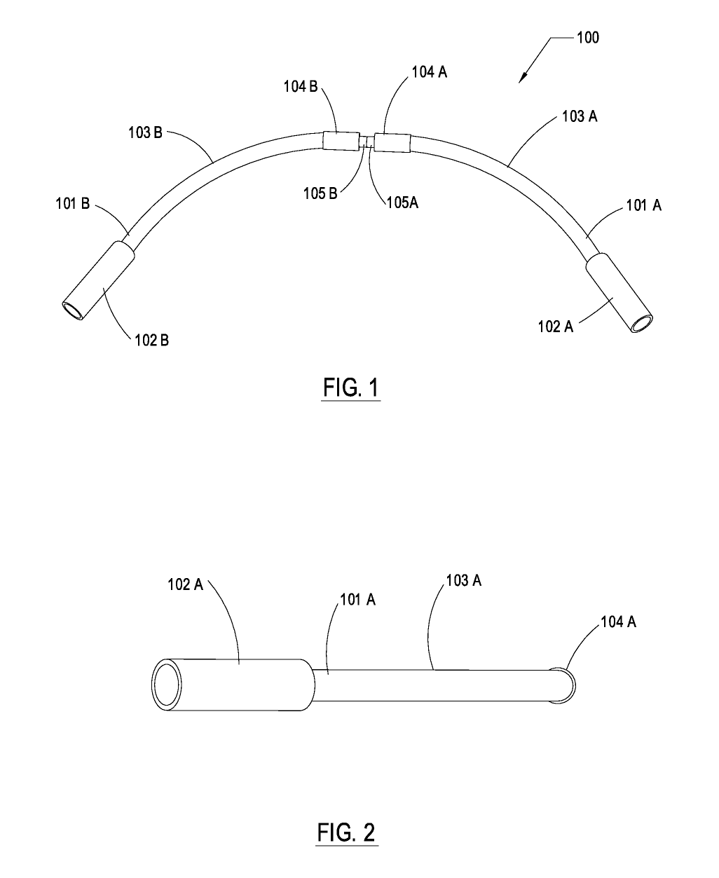

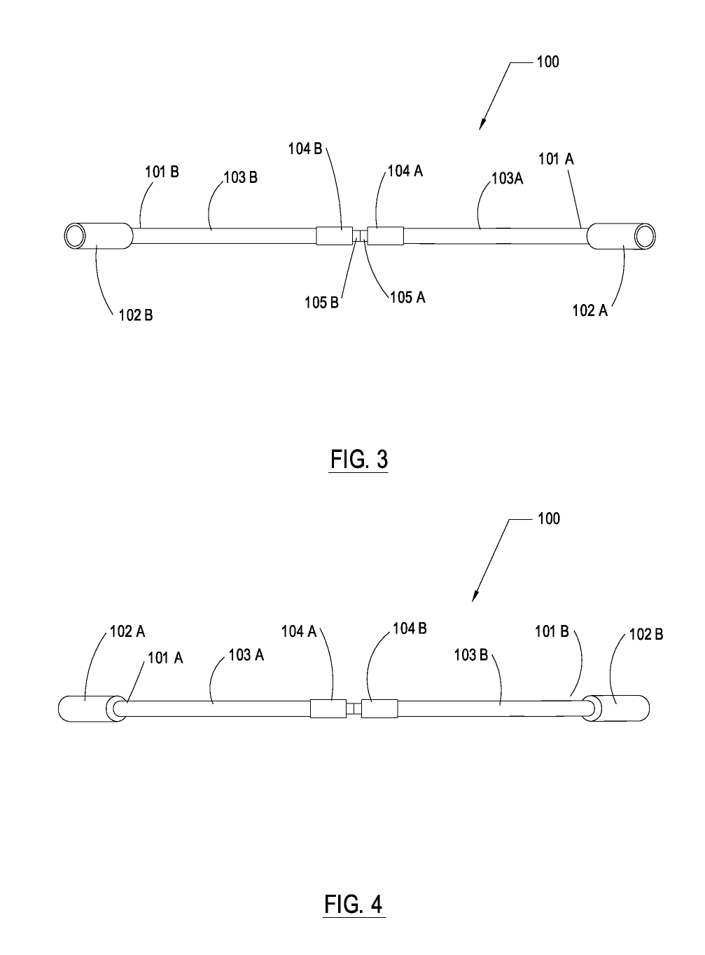

Referring to the drawings wherein like reference characters designate like or corresponding parts throughout the several views, and referring particularly to FIGS. 1-8, it is seen that the present invention includes various embodiments of eyewear retaining device 100 that includes two separable elongate portions 101A and 101B, each of which may have a receiving end (102A, 102B) for receiving an end of a temple member of the eyewear, a connecting end (104A, 104B) having a magnetic fastener (105A, 105B) therein, and an elongate portion for wrapping around the human head (103A, 103B), being continuous at a first end with the receiving end and continuous at a second end with the connecting end. After the receiving ends 102A and 103A of the two elongate members 101A and 101B are attached to the ends of the temples of a pair of eyewear, the elongate portions 103A and 103B may be wrapped around the sides and back of the head of a person such that the connecting ends 104A and 104B are brought together at the back of the head and the magnetic fasteners (105A, 105B) are magnetically connected. It is to be appreciated that, advantageously, the attractive magnetic force between magnet fasteners 105A and 105B enable connecting ends 104A and 104B to “find” each other and self-engage. As such, a wearer only need to position the connecting ends 104A and 104B in proximity to each other.

As illustrated in FIG. 7, the eyewear retaining device 100 may snuggly hold the eyewear at the bridge of the nose. The eyewear retaining device 100 may be sized for various head sizes, and may also be made from elastic material to accommodate human heads of different sizes (e.g., the elasticity of portions of the eyewear retaining devices may enable the eyewear retaining device to stretch by up to 1.5 inches to accommodate head sizes that vary in circumference by 1.5 inches).

The design of eyewear retaining device 100 can be seen from the perspective, side, frontal, and rear views of the device provided in FIGS. 1-4. Although the receiving ends 102A, 102B, the connecting ends 104A, 104B, and the elongate portions for 103A, 103B, are illustrated as tubular structures (e.g., rubber tubing) in the exemplary figures, the invention is not limited to such constructions, and the receiving ends, the elongate portions, and/or the connecting ends may have other shapes or constructions. For example, the receiving ends may comprise elastic loops, cinchable loops, or other structures. In other examples, and without limitation, the elongate portions may be strings, wires, or cables that tie to fasteners on the receiving ends and the connecting ends, may be flat bands (e.g., stretchable neoprene material), may be adjustable straps (e.g., nylon or other polymeric straps having a buckle for adjusting length), or may be formed of other materials or comprise different shapes.

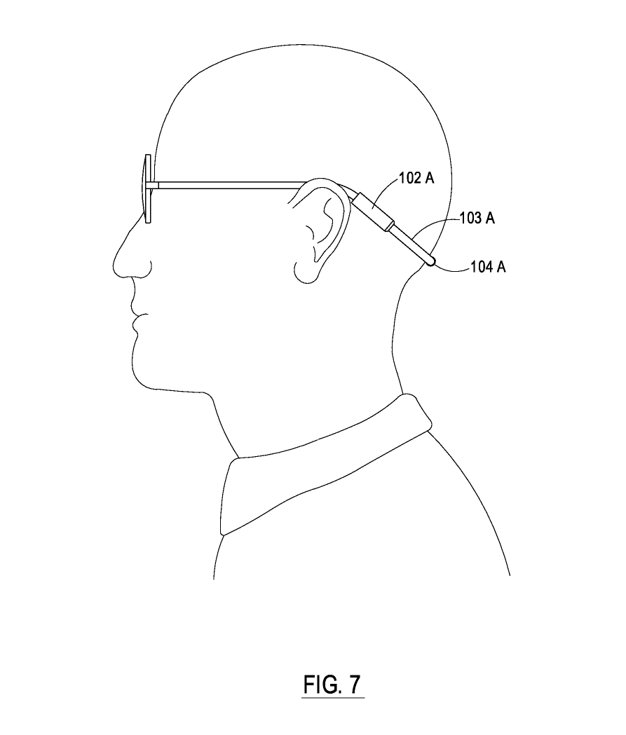

The receiving ends 102A, 102B may have an axial inner opening and may be radially elastic. For example, and without limitation, FIG. 6 illustrates receiving ends 102A, 102B having axial openings therein for receiving and end of the temple portions of the eyewear. It is to be appreciated that the inner diameter of the receiving ends may equal to or less than an outer diameter of the end of the temple portion of the eyewear such that the receiving ends may tightly receive the temple portions. In some examples, the inner diameter of the receiving ends can be smaller than the outer diameter of the end of the temple portions, and the radial elasticity of the receiving ends may be sufficient to tightly engage the temples therein.

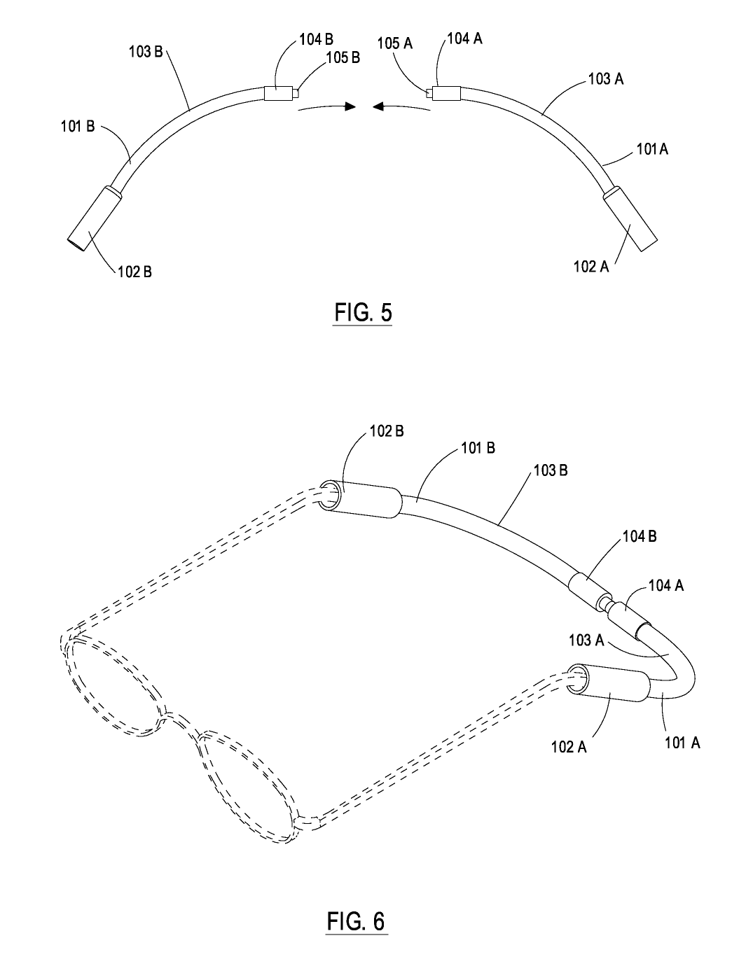

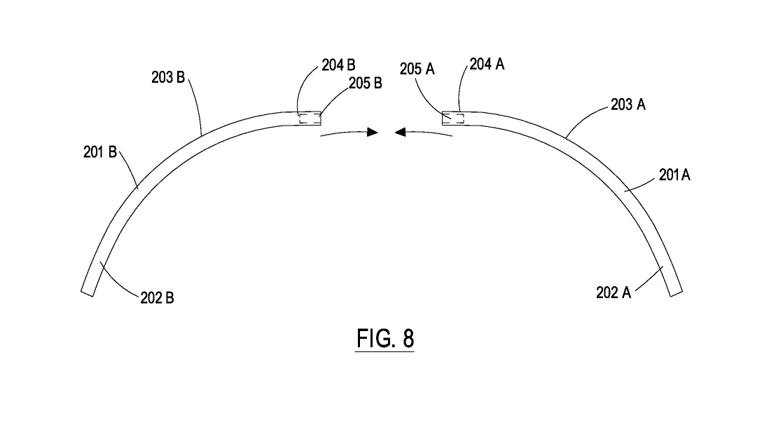

In some embodiments, the connecting ends 104A, 104B, may have an axial inner opening for receiving magnetic fasteners 105A and 105B therein. In some embodiments, the magnetic fasteners may be at least partially inserted into the axial opening of the connecting ends. In some implementations, and as illustrated in the example of FIG. 5, the magnetic fasteners 105A, 105B may have an end which protrudes from the connecting ends 104A, 104B. In some implementations, and as illustrated in the example of FIG. 8, the magnetic fasteners 205A, 205B may have an end which protrudes from the connecting ends 204A, 204B. However, the invention is not limited to such embodiments, and the connecting ends may have other configurations of magnetic fasteners. In some embodiments, the magnetic fasteners may be attached to a distal end of the connecting ends. For example, and without limitation, the magnetic fasteners may be attached to distal ends of the connecting ends by adhesive or glue. In other examples, the magnetic fasteners may have a hole therethrough, and the connecting ends may have portions for engaging in such hole of the magnetic fasteners.

The magnetic fasteners may be permanent magnets and/or comprise ferromagnetic material (such as, and without limitation, iron, cobalt, nickel, and the like). In some embodiments, both magnetic fasteners may be permanent magnets. In some embodiments, one magnetic fastener (e.g., magnetic fastener 105A) may be a permanent magnet and the other fastener (e.g., magnetic fastener 105B) may comprise ferromagnetic material.

Elongate members and or portions thereof may be elastic axially along the length thereof. In some embodiments, elongate portions 103A, 103B, connecting ends 104A, 104B, and/or receiving ends 102A, 102B may be axially elastic. For example, and without limitation, they may be formed of elastic material such as silicone or neoprene. The axially elasticity is such that the first and the second elongate members may stretch when the magnetic fasteners are engaged to each other and may also stretch to accommodate a range of users heads. In some implementations, the receiving ends and/or elongate portions may be axially elastic and the connecting ends may be relatively inelastic. For example, and without limitation, the connecting ends and elongate portions may comprise silicone tubing and the connecting end may be formed of rigid (e.g., formed of rigid plastic, latex, or rubber). In some other examples, the connecting ends and receiving ends may be rigid and the elongate portions may be axially elastic. In some embodiments, the elongate portions may have substantially the same length such that when the device is installed on a users head, the magnetic fasteners of the connecting ends magnetically engage and secure the eyewear to the user.

The connecting ends and/or receiving ends may be fixedly engaged to the elongate portion or may be integrally formed with the elongate portion. As illustrated in the example of FIG. 5, for example and without limitation, connecting end 102B may comprise a silicone tubing having a first diameter and engaged to elongate portion 103B comprising a silicone tubing having a second diameter. In some implementations, the connecting end may be glued or otherwise adhesively connected to the elongate portion. However, as illustrated in the example of FIG. 8, the connecting end 202B may be integrally formed with elongate portion 203B (for example and without limitation, connecting end 202B and elongate portion 203B may be a single piece of silicone tubing). Similarly, in some embodiments, receiving end 204B may be integrally formed with elongate portion 203B. It is to be appreciated that, in some implementations, each elongate member may be a single piece of silicone tubing having a magnetic fastener in an opening on a connecting end while in some embodiments, the elongate member may be formed of two or more portions of silicone tubing adhesively connected to each other. Other configurations are contemplated in accordance with some embodiments of the present invention.

FIGS. 5-6 show how the two elongate members 101A, 101B of the eyewear retaining device 100 may be connected together and how the eyewear retaining device 100 may be connected to a pair of eyeglasses. The arrows in FIG. 5 show how magnetic fasteners 105A and 105B of the connecting ends 104A, 104B may be brought together to fasten the eyewear retaining device 100 behind a person's head. FIG. 6 shows the eyewear retaining device connected to a pair of glasses, with the receiving ends 102A, 102B engaged with the distal ends of temples of the eyeglasses. The receiving ends 102A, 102B may be stretched over ends of temple members to have a snug fit thereon. The receiving ends may have a shape and elasticity that accommodates eyeglass temples of various sizes.

FIG. 7 shows a side view of the eyewear retaining device 100 in use by a person. The eyewear retaining device is shown attached to a pair of eyeglasses worn by the person, with the connecting ends 104A, 104B holding the elongate members 101A, 101B snuggly to the person's head. As shown in FIG. 7, the eyewear retaining device 100 may hold the eyeglasses snuggly to the bridge of the person's nose in the proper position (such that the lens are in front of the eyes). The eyewear retaining device may also allow the eyewear to be easily and comfortably donned and removed by use of magnetic fasteners 105A and 105B of connecting members 104A, 104B.

Thus, the present invention provides an eyewear retaining device that prevents slippage or displacement of eyewear, while allowing the wearer to quickly and comfortably remove the eyewear.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed:

1. A device for securing eyewear to a human head and prevent the eyewear from slipping from the bridge of the nose, said device comprising a first elongate member and a second elongate member, each elongate member including:
i. a receiving end for receiving an end of a temple member of said eyewear,
ii. a connecting end having a magnetic fastener, and
iii. an elongate portion between said receiving end and said connecting end for wrap around a portion of said human head,
wherein said magnetic fastener of said first elongate member and said magnetic fastener of said second elongate member are adapted to magnetically engage each other behind said human head.

2. The device of claim 1, wherein at least a portion of said first and second elongate members are axially elastic such that said first and said second elongate members may stretch when said magnetic fasteners are engaged to each other.

3. The device of claim 1, wherein said receiving end is radially elastic.

4. The device of claim 1, wherein said first and said second elongate members have substantially the same length.

5. The device of claim 1, wherein said elongate portion is integrally formed with said receiving end.

6. The device of claim 1, wherein said elongate portion is integrally formed with said connecting end.

7. The device of claim 1, wherein said elongate portion is integrally formed with said receiving end and with said connecting end.

8. The device of claim 1, wherein said magnetic fastener is at least partially inserted in an axial opening of said connecting end.

9. The device of claim 8, wherein and end of said magnetic fastener protrudes from said axial opening of said connecting end.

10. The device of claim 1, wherein said magnetic fastener is attached to a distal end of said connecting end.

11. The device of claim 1, wherein at least one of said magnetic fastener of said first connecting end and said magnetic fastener of said second connecting end is a permanent magnet.

12. The device of claim 11, wherein at least one of said magnetic fastener of said first connecting end and said magnetic fastener of said second connecting end comprises a ferromagnetic material.

13. The device of claim 11, wherein each of said magnetic fastener of said first connecting end and said magnetic fastener of said second connecting end is a permanent magnet.

14. A device for use with eyewear having a first temple portion and a second temple portion, said device comprising:
a. a first elongate member comprising a receiving end capable of tightly receiving an end of said first temple portion of said eyewear, a connecting end having a first magnetic fastener, and an elongate portion between said receiving end and said connecting end;
b. a second elongate member comprising a receiving end capable of tightly receiving an end of said second temple portion of said eyewear, a connecting end having a second magnetic fastener, and an elongate portion between said receiving end said connecting end;
wherein said first and said second magnet fasteners are oriented with said connecting ends of said first and said second elongate members, respectively, such that said magnetic fasteners may be magnetically engaged to each other at distal ends of said connecting ends.

15. The device of claim 14, wherein said receiving end, said elongate portion, and said receiving end of each of said first and said second elongate members are integrally formed.

16. The device of claim 14, wherein each said first and said second magnetic fasteners are permanent magnets.

17. The device of claim 14, wherein said first magnetic fastener is at least partially inserted in an axial opening in said connecting end of said first elongate portion, and wherein said second magnetic fastener is at least partially inserted in an axial opening in said connecting end of said second elongate portion.

18. The device of claim 14, wherein said receiving end of said first elongate portion includes an axial opening therein for receiving a proximal end of said first temple portion of said eyewear, and wherein said receiving end of said second elongate portion includes an axial opening therein for receiving a proximal end of said second temple portion of said eyewear.

19. An eyewear retaining device comprising two elongate members, each elongate member having:
a. a receiving end having an axial opening therein for receiving an end of one of two temple members of a pair of eyewear, wherein said receiving end is radially elastic;
b. a connecting end opposite to said receiving end, said connecting end having an axial opening therein for receiving a magnetic fastener; and
c. an elongate portion between said receiving end and said connecting end, wherein a portion of said elongate portion is axially elastic,
wherein said first and second elongate members have about the same length and are adapted to wrap around a human head wearing said pair of eyewear such that said first and second magnetic fasteners magnetically engage each other at a location behind said human head .

20. The device of claim 19, wherein each said magnetic fastener comprises a permanent magnet.

21. The device of claim 20, wherein said receiving end is engaged with said elongate portion and has an outer diameter that is greater than an outer diameter of said elongate portion.
